(19) United States
(12) Patent Application Publication
(10) Pub. No.: US 2025/0259282 A1
(43) Pub. Date: Aug. 14, 2025

(54) ELECTRONIC DEVICE AND IMAGE PROCESSING METHOD FOR ELECTRONIC DEVICE

(71) Applicant: SAMSUNG ELECTRONICS CO., LTD., Suwon-si (KR)

(72) Inventors: Moonhwan JEONG, Suwon-si (KR); Keunjoo KWON, Suwon-si (KR); Mansung KIM, Suwon-si (KR)

(21) Appl. No.: 19/194,689

(22) Filed: Apr. 30, 2025

Related U.S. Application Data
(63) Continuation of application No. PCT/KR2023/017889, filed on Nov. 8, 2023.

(30) Foreign Application Priority Data
Nov. 8, 2022 (KR) 10-2022-0148237
Dec. 21, 2022 (KR) 10-2022-0180735

(51) Int. Cl. G06T 5/77; G06T 3/4038; G06T 3/4053; G06T 5/50; G06T 7/11

(52) U.S. Cl. CPC G06T 5/77; G06T 3/4038; G06T 3/4053; G06T 5/50; G06T 7/11; G06T 2207/20132; G06T 2207/20224

(57) ABSTRACT

An electronic device may include a communication circuit, a memory, and a processor(s). The processor(s) may be configured to generate a first image by downsampling an original image, to generate a second image by removing a partial component included in the first image from the first image, to generate a difference image between the first image and the second image, to determine a number of times that the difference image is stepwise upsampled to have a resolution corresponding to a resolution of the original image, to generate an upsampled difference image by stepwise upsampling the difference image the determined number of times, to generate a final/resulting image, which corresponds to a resolution of the original image and in which the partial component is removed from the original image, based on the original image and the upsampled difference image, and to store the final/resulting image in the memory. Besides, other various embodiments identified through the specification are also possible.

### CROSS-REFERENCE TO RELATED APPLICATIONS

This application is a continuation application of International Application No. PCT/KR2023/017889 designating the United States, filed on Nov. 8, 2023, in the Korean Intellectual Property Receiving Office and claiming priority to Korean Patent Application No. 10-2022-0148237, filed on Nov. 8, 2022, and Korean Patent Application No. 10-2022-0180735, filed on Dec. 21, 2022, the disclosures of which are all hereby incorporated by reference herein in their entireties.

### BACKGROUND

### Technical Field

Certain example embodiments may relate to a technology for processing an original image.

### Background Art

An electronic device may capture a high-resolution image by using a camera or may provide a function of editing an image. Nowadays, a technology has been developed to create an image that a user wants, by correcting the captured image when an electronic device captures the image. The electronic device may correct images by using an artificial intelligence (AI)-based model. When the AI-based model is used, the operating time and resource requirements may increase, and thus there is a need for a technology that converts an original image into a low-resolution image when the image is corrected, corrects the low-resolution image, and upsamples the corrected image such that the upsampled image has the resolution of the original image.

### SUMMARY

An electronic device according to an example embodiment may include a communication circuit, a memory, and a at least one processor comprising processing circuitry. The at least one processor may be individually and/or collectively configured to generate a first image by at least downsampling an original image, to generate a second image by at least removing a partial component included in the first image from the first image, to generate a difference image between the first image and the second image, to determine a number of times that the difference image is stepwise upsampled to have a resolution corresponding to a resolution of the original image, to generate an upsampled difference image by at least stepwise upsampling the difference image the determined number of times, to generate a final image, which corresponds to a resolution of the original image and in which the partial component is removed from the original image, based on the original image and the upsampled difference image, and to store the final image in the memory.

An image processing method of an electronic device according to an example embodiment may include generating a first image by downsampling an original image, generating a second image by removing a partial component included in the first image from the first image, generating a difference image between the first image and the second image, determining a number of times that the difference image is stepwise upsampled to have a resolution corresponding to a resolution of the original image, generating an upsampled difference image by stepwise upsampling the difference image the determined number of times, generating a final and/or resulting image, which corresponds to the resolution of the original image and in which the partial component is removed from the original image, based on the original image and the upsampled difference image, and storing the final and/or resulting image.

According to an example embodiment, a storage medium may store instructions that, when executed by a processor, cause an electronic device to perform the image processing method.

### BRIEF DESCRIPTION OF DRAWINGS

FIG. 1 is a block diagram of an electronic device, according to an example embodiment.

FIG. 2 is a drawing for describing an operation of an electronic device, according to an example embodiment.

FIG. 3 is a drawing for describing an operation of an electronic device, according to an example embodiment.

FIG. 4 is a drawing for describing an operation of an electronic device, according to an example embodiment.

FIG. 5 is a drawing for describing an operation of an electronic device, according to an example embodiment.

FIG. 6 is a block diagram of an electronic device, according to an example embodiment.

FIG. 7 is a diagram for describing an operation of an electronic device, according to an example embodiment.

FIG. 8 is a flowchart of an image processing method of an electronic device, according to an example embodiment.

FIG. 9 is a flowchart of an image processing method of an electronic device, according to an example embodiment.

FIG. 10 illustrates an electronic device in a network environment, according to various example embodiments.

With regard to description of drawings, the same or similar components will be marked by the same or similar reference signs.

### DETAILED DESCRIPTION

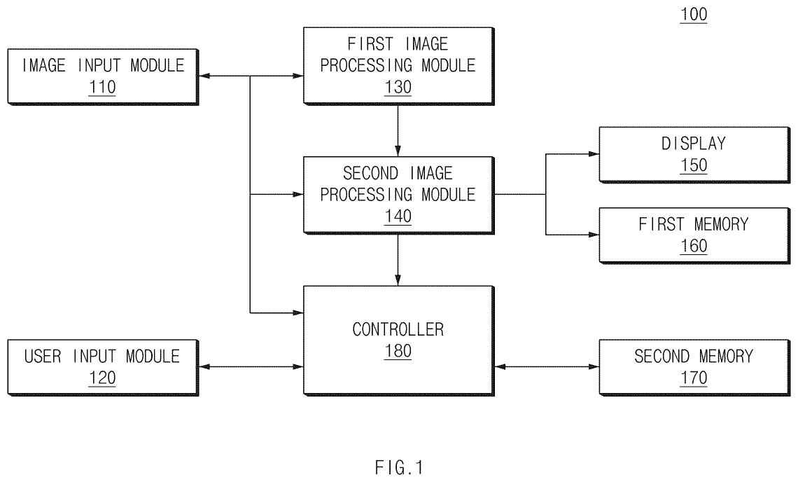

FIG. 1 is a block diagram of an electronic device, according to an embodiment.

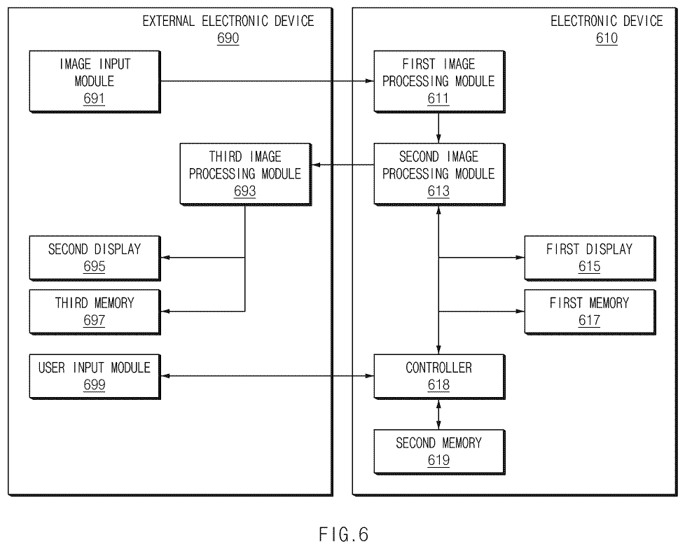

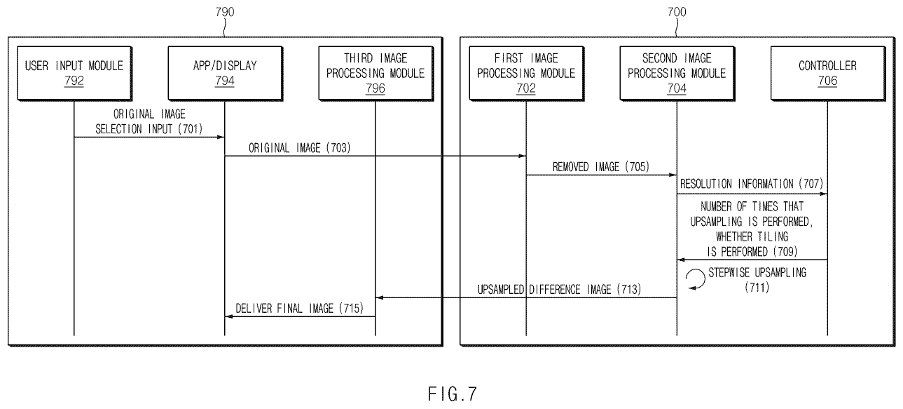

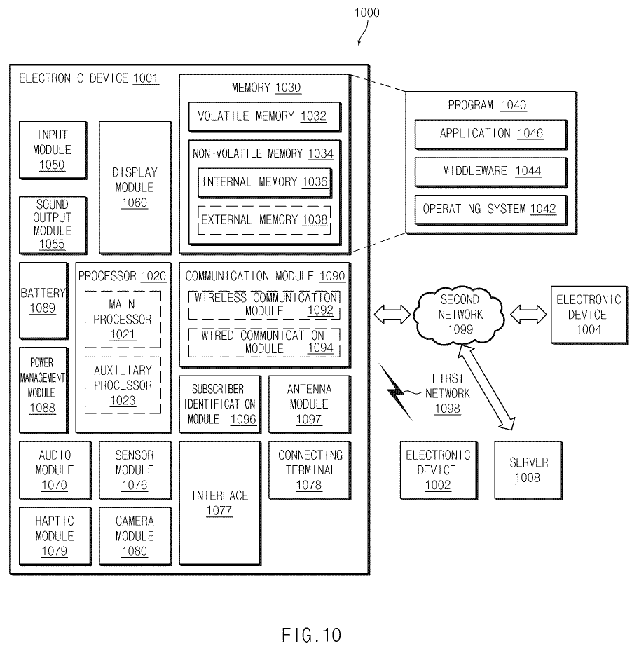

According to an embodiment, an electronic device 100 (e.g., an electronic device 610 of FIG. 6, an electronic device 700 of FIG. 7, or an electronic device 1001 of FIG. 10) may include an image input module 110, a user input module 120 (e.g., an input module 1050 of FIG. 10), a first image processing module 130 (e.g., a first image processing module 611 of FIG. 6, a first image processing module 702 of FIG. 7, or a processor 1020 of FIG. 10), a second image processing module 140 (e.g., a second image processing module 613 of FIG. 6, a second image processing module 704 of FIG. 7, or the processor 1020 of FIG. 10), a display 150 (e.g., a first display 615 of FIG. 6, a display module 1060 of FIG. 10), a first memory 160 (e.g., a first memory 617 of FIG. 6 or a memory 1030 of FIG. 10), a second memory 170 (e.g., a second memory 619 of FIG. 6 or a volatile memory 1032 of FIG. 10), and a controller 180 (e.g., a controller 618 of FIG. 6, a controller 706 of FIG. 7, or the processor 1020 of FIG. 10).

According to an embodiment, the image input module 110 may obtain an original image. For example, the image input module 110 may include a camera. The image input module 110 may capture the original image by using the camera. For example, the image input module 110 may include a communication circuit. The image input module 110 may receive the original image from an external device through the communication circuit. The image input module 110 may provide the original image to the first image processing module 130, the second image processing module 140, and/or the controller 180.

According to an embodiment, the user input module 120 may receive a user input. For example, the user input module 120 may receive, from a user, an input for selecting the original image, an input for editing an image, and/or an input for displaying an image (e.g., an original image, a difference image, an intermediate image generated during stepwise upsampling, and/or a final image). The user input module 120 may receive various inputs for controlling an operation of the electronic device 100.

According to an embodiment, the first image processing module 130 may generate a first image by downsampling the original image. The first image processing module 130 may generate a second image by removing some components from the downsampled first image. According to an embodiment, some components may include a shadow image and/or a light reflection image. For example, the first image processing module 130 may remove some components from the first image by using the trained AI learning model (e.g., an image processing model trained through machine learning (e.g., deep learning)). For example, the first image processing module 130 may reduce the time and the amount of computation required to correct an image (e.g., removing some components) by removing some components from the downsampled first image without directly removing some components from the original image. The first image processing module 130 may generate a difference image based on the first image and the second image. For example, the first image processing module 130 may generate a difference image by subtracting a value of each of pixels of the corresponding first image from a value of each of the pixels of the second image. For example, the first image processing module 130 may generate the difference image by subtracting the value of each of the pixels of the second image from the value of each of the pixels of the first image and then inverting the values of the pixels (e.g., conversion to a value symmetrical to a reference value). The difference image may correspond to the removed components (e.g., the shadow image and/or the light reflection image). The first image processing module 130 may provide the second image and/or the difference image to the second image processing module 140.

According to an embodiment, the second image processing module 140 may perform a stepwise upsampling operation. For example, the second image processing module 140 may generate a final image of a resolution corresponding to the resolution of the original image by correcting (editing) the downsampled image and then stepwise upsampling the corrected image. The second image processing module 140 may perform upsampling based on information, which is received from the controller 180 and which is related to the number of times that stepwise upsampling is performed, whether to perform tiling, whether a tile image is padded/cropped, the number of tile images, and/or the size of the tile image.

According to an embodiment, the second image processing module 140 may split the difference image (and the original image) into a plurality of first tile images. When a computational memory of a processor exceeds a predetermined threshold value, the second image processing module 140 may split the difference image into a plurality of tile images. The second image processing module 140 may stepwise upsample each of the tile images. The second image processing module 140 may not perform upsampling of a tile image satisfying a specified condition (e.g., a case where the sum of values of pixels of a tile image is 0). In this case, the second image processing module 140 may generate the final image by using the corresponding original tile image instead of the tile image. The second image processing module 140 may generate the final image, of which the resolution corresponds to the resolution of the original image and in which some components are removed from the original image, based on the original image and the upsampled difference image. For example, the second image processing module 140 may generate the final image by adding the upsampled difference image to the original image. For example, the second image processing module 140 may generate the final image by adding a value of each pixel of the upsampled difference image to a value of each pixel of the original image. The second image processing module 140 may store the final image in a memory.

In FIG. 1, the first image processing module 130 and the second image processing module 140 are illustrated as separate configurations from each other, but are not limited thereto. For example, the first image processing module 130 and the second image processing module 140 may be implemented as one module and may be implemented integrally with the controller 180. The electronic device 100 may further include an image processing module.

According to an embodiment, the display 150 may display an image. For example, the display 150 may display the original image, the downsampled image, the difference image, the intermediate image, and/or the final image. According to an embodiment, the display 150 and the user input module 120 may be implemented with one module (e.g., a touch screen display 150).

According to an embodiment, the first memory 160 may store instructions that control the operation of the electronic device 100 when executed by the processor. According to an embodiment, the first memory 160 may at least temporarily store an image. For example, the first memory 160 may store, at least temporarily, the original image, the downsampled image, the difference image, the intermediate image, and/or the final image. The first memory 160 may store information and/or data related to the operation of the electronic device 100.

According to an embodiment, the second memory 170 may store data for the calculation of the processor. For example, the second memory 170 may include the computational memory (e.g., RAM) of the processor. According to an embodiment, the first memory 160 and the second memory 170 may be implemented as one physical memory. For example, the first memory 160 and the second memory 170 may be implemented as different storage areas in one memory.

According to an embodiment, the controller 180 may control the overall operation of the electronic device 100. The controller 180 may determine the number of times that the difference image is stepwise upsampled to have a resolution corresponding to the resolution of the original image. The electronic device 100 may determine the number of times that upsampling is performed, based on a specified upsampling (resolution) multiple (e.g., ‘n’ times), the resolution of the original image, and the resolution (e.g., a first resolution) of the downsampled image. The controller 180 may determine whether to tile the difference image (and the original image). For example, the controller 180 may recognize whether the computational memory (or an operating memory) of the controller 180 exceeds a predetermined threshold value. The controller 180 may recognize whether out-of-memory (OOM) occurs. When the computational memory exceeds the predetermined threshold value, the controller 180 may determine to split the difference image (and the original image) into a plurality of tile images. When the computational memory is smaller than or equal the predetermined threshold value, the controller 180 may determine not to split the difference image (and the original image) into the plurality of tile images. The controller 180 may determine the number and/or sizes of tiles under the condition that the operating memory does not exceed a specified free memory. For example, the controller 180 may determine the number and/or sizes of tiles based on the resolution of the original image and/or the output resolution (e.g., a downsampling resolution) of the AI learning model used to remove components. For example, the controller 180 may determine the number of tile images as one of divisors of the resolution of the model output (e.g., the downsampled first image). The controller 180 may determine not to perform upsampling of a tile image that satisfies a specified condition (e.g., a case where the sum of values of pixels of a tile image is 0). In this case, the controller 180 may use a tile image (e.g., the original tile image) of the original image corresponding to the tile image, on which upsampling is not performed to generate the final image. The controller 180 may determine whether to pad the difference image and/or to crop the upsampled difference image. The controller 180 may transmit information related to the number of times that stepwise upsampling is performed, whether to perform tiling, whether a tile image is padded/cropped, the number of tile images, and/or the size of the tile image. The controller 180 may control operations of the first image processing module 130 and/or the second image processing module 140 based on the number of times that stepwise upsampling is performed, whether to perform tiling, whether a tile image is padded/cropped, the number of tile images, and/or the size of the tile image. The controller 180 may perform the specified operation (e.g., outputting a thumbnail image, outputting a preview image, and/or editing an image) based on an intermediate image (e.g., an image generated at each step of upsampling) generated during the stepwise upsampling.

According to an embodiment, the first image processing module 130, the second image processing module 140, and/or the controller 180 may be implemented as a single integrated configuration (e.g., a processor (not shown) (e.g., the processor 1020 of FIG. 10)). According to an embodiment, the first image processing module 130, the second image processing module 140, and/or the controller 180 may be implemented as at least one hardware module and may be implemented as at least one software module so as to be executed by at least one processor (not shown) (e.g., the processor 1020 of FIG. 10) of an electronic device.

According to an embodiment, the electronic device 100 may reduce the damage and loss of details of the original image capable of being generated during upsampling by upsampling the difference image and utilizing the original image when the final image is generated. The electronic device 100 may reduce the amount of computation (e.g., operating memory consumption) and image processing time of the processor by tiling an original image and a difference image and upsampling and/or compositing the tiled result. The electronic device 100 may prevent or reduce chances of an image from being damaged at a border of a tile image by applying padding and cropping to the tile image. The electronic device 100 may reduce image damage capable of occurring during upsampling by performing recursive upsampling, and may utilize the intermediate image generated during upsampling for a specified function and/or a specified operation.

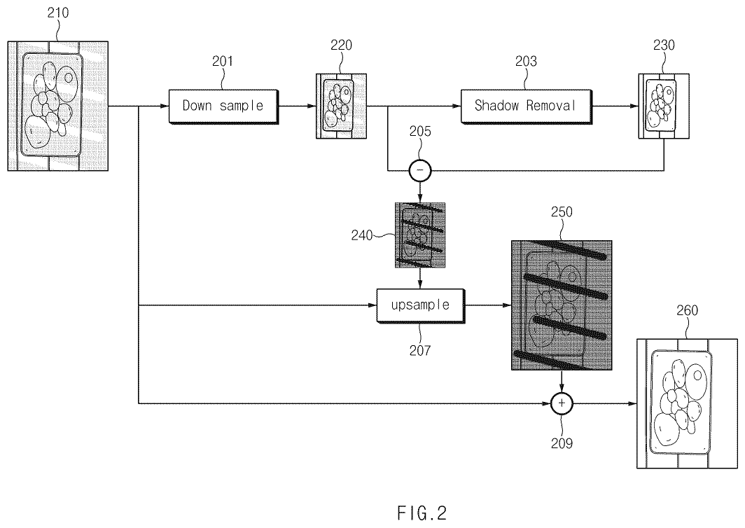

FIG. 2 is a drawing for describing an operation of an electronic device, according to an embodiment.

According to an embodiment, in operation 201, an electronic device (e.g., the electronic device 100 of FIG. 1, the electronic device 610 of FIG. 6, the electronic device 700 of FIG. 7, or the electronic device 1001 of FIG. 10) may generate a first image 220 by downsampling an original image 210. For example, an electronic device may generate the first image 220 by downscaling the resolution of the original image 210.

According to an embodiment, in operation 203, the electronic device may generate a second image 230 by removing some components (e.g., shadow image and/or light reflection image) from the first image 220. For example, the electronic device may remove some components from the first image 220 based on the trained artificial intelligence model.

According to an embodiment, in operation 205, the electronic device may generate a difference image 240 based on the first image 220 and the second image 230. For example, an electronic device may generate the difference image 240 by subtracting a value of each of pixels in the first image 220 from a value of each of pixels in the second image 230. For example, the electronic device may generate the difference image 240 by subtracting the value of each of the pixels of the second image 230 from the value of each of the pixels of the first image 220 and then inverting the values of the pixels (e.g., conversion to a value symmetrical to a reference value).

According to an embodiment, in operation 207, the electronic device may generate a third image 250 by upsampling the difference image 240. For example, the difference image 240 may have a smaller capacity than the third image 250. For example, an electronic device may upsample the difference image 240 by using a joint up-sampling method. An electronic device may generate the third image 250 having a resolution corresponding to the resolution of the original image 210 by upsampling the difference image 240. For example, the difference image 240 may not have details (e.g., contours and/or boundaries) as many as the second image 230. Accordingly, the loss or damage of the image according to upsampling may be reduced in the case where the difference image 240 is upsampled, compared to the case where the second image 230 is upsampled. Moreover, because pixel values of areas without components (e.g., shadows and/or light reflections) in the difference image become 0, image damage capable of occurring during upsampling may be reduced.

According to an embodiment, in operation 209, the electronic device may generate a final image 260 based on the original image 210 and the third image 250. For example, the electronic device may generate the final image 260 by adding the third image 250 to the original image 210. For example, the electronic device may generate the final image 260 by adding a value of each of pixels of the third image 250 to a value of each of pixels of the original image 210.

For example, the above-described operations in which the electronic device generates the final image 260 may be expressed in an equation as follows.

$$O = I + Up ( Down ( I ) - f ( Down ( I ) ) ) \qquad [ Equation 1 ]$$

Here, ‘O’ denotes the final image 260; ‘I’ denotes the original image 210; ‘f’ denotes component removal (e.g., shadow removal and/or light reflection removal) using an AI model; ‘Down’ denotes downsampling; and ‘Up’ denotes upsampling.

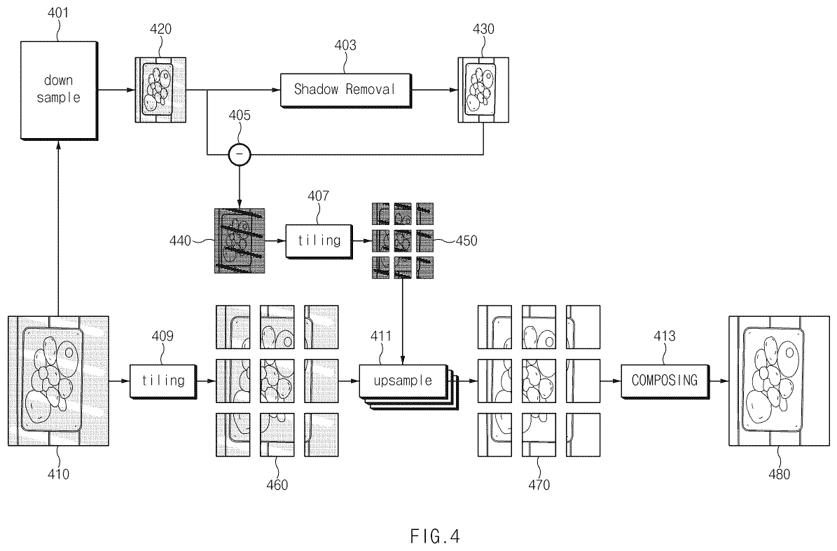

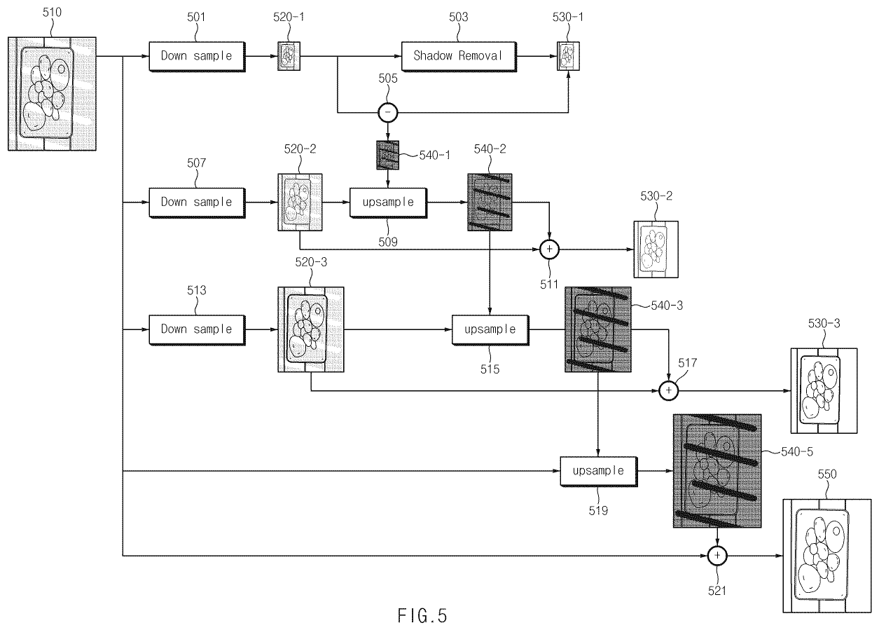

According to an embodiment, at least some of the operations of FIG. 2 may be performed, simultaneously or in a different order, and at least some operations may be omitted or new operations (e.g., operations of FIG. 4 or FIG. 5) may be added.

According to an embodiment, the electronic device may not directly upsample the second image 230, but may generate the third image 250 by generating and upsampling the difference image 240 and may generate the final image 260 based on the original image 210 and the third image 250, thereby reducing the processing time and computational amount required for image processing compared to the case where the second image 230 is upsampled. According to an embodiment, the electronic device may upsample the difference image 240 and may utilize the original image 210 when generating the final image 260, thereby reducing damage and loss of details of the original image 210 capable of occurring during upsampling compared to the case where the second image 230 is upsampled.

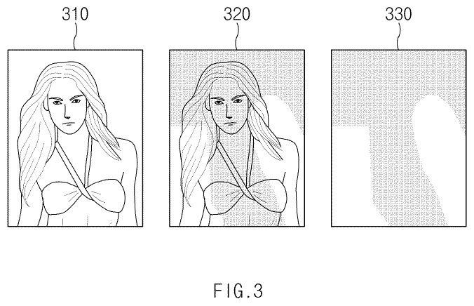

FIG. 3 is a drawing for describing an operation of an electronic device, according to an embodiment.

According to an embodiment, an electronic device (e.g., the electronic device 100 of FIG. 1, the electronic device 610 of FIG. 6, the electronic device 700 of FIG. 7, or the electronic device 1001 of FIG. 10) may generate a difference image by removing some components from an original image. The electronic device may generate a final image, in which some components are removed, based on the difference image. For example, some components may include a shadow image and/or a light reflection image included in the original image. For example, ‘320’ represents the original image; ‘330’ represents a difference image; and ‘310’ represents the final image.

FIG. 3 shows an example, and the original image, the difference image, and the final image are not limited to those shown in FIG. 3.

FIG. 4 is a drawing for describing an operation of an electronic device, according to an embodiment. Hereinafter, descriptions the same as those in FIG. 2 are briefly given or omitted.

According to an embodiment, in operation 401, an electronic device (e.g., the electronic device 100 of FIG. 1, the electronic device 610 of FIG. 6, the electronic device 700 of FIG. 7, or the electronic device 1001 of FIG. 10) may generate a first image 420 by downsampling an original image 410.

According to an embodiment, in operation 403, the electronic device may generate a second image 430 by removing some components (e.g., shadow image or light reflection image) from the first image 420.

According to an embodiment, in operation 405, the electronic device may generate a difference image 440 corresponding to the removed component based on the first image 420 and the second image 430.

According to an embodiment, in operation 407, the electronic device may split the difference image 440 into a plurality of first tile images 450. For example, the electronic device may recognize whether the computational memory (or an operating memory) of a processor exceeds a predetermined threshold value. The electronic device may recognize whether OOM occurs. When the computational memory of the processor exceeds the predetermined threshold value, the electronic device may split the difference image 440 into the first tile image 450. When the computational memory of the processor does not exceed the predetermined threshold value, the electronic device may not split the difference image 440 (and the original image 410) into a plurality of tile images.

According to an embodiment, the electronic device may determine the number and/or sizes of tiles under the condition that the operating memory of the processor does not exceed a specified free memory. For example, the electronic device may determine the number and/or sizes of tiles based on the resolution of the original image 410 and/or the output resolution (e.g., a downsampling resolution) of the AI learning model used to remove components.

For example, the electronic device may determine the number and/or sizes of tiles satisfying Equation 2 below.

$${N}_{w} E \frac{Orig {inal}_{w}}{O u t p u {t}_{w}} , {N}_{h} D \frac{Orig {inal}_{h}}{O u t p u {t}_{h}} \qquad [ Equation 2 ]$$

N_{w} denotes the number of divisions in a horizontal (width) direction; Nₕ denotes the number of divisions in a vertical (height) direction; Original_{w} denotes a resolution of the original image 410 in the horizontal (width) direction; Output_{w} denotes the resolution of a model (e.g., the downsampled image) in the horizontal (width) direction; Originalₕ denotes the resolution of the original image 410 in the vertical (height) direction; and Outputₕ denotes the resolution of the model (e.g., the downsampled image) in the vertical (height) direction.

For example, when the resolution of the original image 410 is 3000×4000 and the model output (the resolution of the downsampled image) is 312×416, the electronic device may determine that the number of tiles is 10 or more horizontally and 10 or more vertically. For example, the electronic device may determine the number of tiles in the horizontal direction to be 10 or more and the number of tiles in the vertical direction to be 10 or more and may split the difference image 440 into the plurality of first tile images 450.

For example, the size of the first tile image 450 may be an integer. As the number of the first tile images 450 increases, the size of each first tile image 450 may decrease. When the number of tile images does not match the resolution of the model output (e.g., the downsampled image), the original image 410 or the difference image 440 may not be evenly split, and thus decimal point operations may occur, resulting in calculation errors. For example, the electronic device may determine the number of tile images as one, which satisfies Equation 2, from among divisors of the resolution of the model output (e.g., downsampled image). For example, when the model output is 312×416, 12 satisfying Equation 2 from among “2, 3, 4, 6, 8, 12, . . . , 312” being divisors of 312 in the horizontal direction, and 13 satisfying Equation 2 from among “2, 4, 8, 13, 16, . . . , 416” being divisors of 416 in the vertical direction may be determined as the number of tiles. For example, the electronic device may split the difference image 440 into 12 (12 columns) in the horizontal direction and 13 (13 rows) in the vertical direction into the first tile images 450. In this case, the size (resolution) of the first tile image 450 may be 26×32.

According to an embodiment, in operation 409, the electronic device may identify the original image 410 as a plurality of original tile images 460. As in operation 407, the electronic device may determine the number and/or size of the original tile image 460 based on Equation 2. For example, the electronic device may split the original image 410 into the plurality of original tile images 460 based on the number of tile images determined in operation 407.

According to an embodiment, in operation 411, the electronic device may generate a second tile image (not shown) by upsampling the first tile image 450. The electronic device may generate a third tile image 470 by combining the original tile image 460 and the second tile image.

According to an embodiment, the electronic device may skip upsampling of at least part of the first tile image 450. For example, when the sum of values of pixels constituting the first tile image 450 is 0, there is no need to upsample the first tile image 450 and to add the upsampled result to the corresponding original pixel image, and thus the upsampling of the first tile image 450 may not be performed.

$$if SUM ( {D}_{i} ) DThreshold : {O}_{i} = {I}_{i} , else : {O}_{i} = {I}_{i} + Up ( {D}_{i} ) \qquad [ Equation 3 ]$$

Dᵢ denotes the i-th first tile image 450; Oᵢ denotes the i-th output image; Iᵢ denotes the i-th original tile image 460; ‘SUM’ denotes the sum of pixel values; ‘Threshold’ denotes the reference value (e.g., 0); and ‘Up’ denotes upsampling. For example, the output image may indicate the third tile image 470 composed to generate a final image 480. According to an embodiment, the electronic device may determine whether to perform upsampling by using the mean or standard deviation of pixel values instead of the sum of pixel values of the first tile image 450.

For example, referring to Equation 3, when the sum of pixel values of the i-th first tile image 450 is less than or equal to the threshold value, the electronic device may use the i-th original tile image 460 for composition to generate the final image 480 without performing upsampling of the i-th first tile image 450 (e.g., without generating the i-th second tile image). For example, the electronic device may not generate a second tile image by upsampling the first tile image 450 that is not related to a component (e.g., shadow image and/or light reflection image) to be removed. In this case, the electronic device may use the original tile image 460 itself to compose the final image 480 without merging the original tile image 460 with the second tile image.

For example, when the difference image 440 is split into the plurality of first tile images 450, a mismatch problem may occur at a boundary between the first tile images 450. After adding padding to the top, bottom, left, and right of each of the first tile images 450, the electronic device may upsample each of the first tile images 450. The electronic device may upsample the first tile image 450 to which padding is added, and then may crop the upsampled first tile image 450. The electronic device may remove a portion corresponding to the added padding from the upsampled first tile image 450. The electronic device may prevent or reduce chances of the first image 420 from being significantly damaged at the boundary of the first tile image 450 through padding (and cropping) operations.

This may be expressed by Equation 4 below.

$${O}_{i} = {I}_{i} + crop ( Up ( pad ( {D}_{i} ) ) ) \qquad [ Equation 4 ]$$

Oᵢ denotes the i-th output image (e.g., the third tile image 470); Iᵢ denotes the i-th original tile image 460; Dᵢ denotes the i-th first tile image 450; ‘crop’ denotes cropping; ‘Up’ denotes upsampling; and ‘pad’ denotes padding.

According to an embodiment, in operation 413, the electronic device may generate the final image 480 by composing the third tile image 470. According to an embodiment, when the electronic device does not generate the second tile image by upsampling the specific first tile image 450 in operation 411, the electronic device may generate the final image 480 by using the corresponding original tile image 460 instead of the second tile image. For example, the electronic device may generate the final image 480 by composing at least one original tile image 460 and the plurality of third tile images 470.

For example, the final image 480 may be an image, which has a resolution corresponding to the original image 410, and in which some components (e.g., a shadow image and/or a light reflection image) are removed from the original image 410.

According to an embodiment, at least some of the operations of FIG. 4 may be performed, simultaneously or in a different order, and at least some operations (e.g., a padding operation and/or a cropping operation) may be omitted or new operations (e.g., operations of FIG. 2 or FIG. 5) may be added.

According to an embodiment, the electronic device may upsample the difference image 440 and may utilize the original image 410 when generating the final image 480, thereby reducing damage and loss of details of the original image 410 capable of occurring during upsampling compared to the case where the second image 430 is upsampled. The electronic device may reduce the amount of computation (e.g., operating memory consumption) and image processing time of the processor by tiling the original image 410 and the difference image 440 and upsampling and/or compositing the tiled result. The electronic device may prevent or reduce chances of an image from being damaged at a border of a tile image by applying padding and cropping to the tile image.

FIG. 5 is a drawing for describing an operation of an electronic device, according to an embodiment. Below, the descriptions given in FIGS. 2 and 4 are briefly given or omitted. For example, FIG. 5 illustrates an operation of performing stepwise upsampling of an electronic device.

According to an embodiment, in operation 501, an electronic device (e.g., the electronic device 100 of FIG. 1, the electronic device 610 of FIG. 6, the electronic device 700 of FIG. 7, or the electronic device 1001 of FIG. 10) may generate a first image 520-1 by downsampling an original image 510 so as to have a first resolution. The electronic device may determine the number of times that stepwise upsampling is performed, based on the first resolution and the resolution of the original image 510. The electronic device may determine to perform stepwise upsampling by a specified multiple. For example, when the electronic device determine to perform recursive upsampling by a factor of ‘n’, the electronic device 100 may determine the number of times that stepwise upsampling is performed, based on a specified upsampling (resolution) multiple (e.g., ‘n’ times), the resolution of the original image 510, and the resolution (e.g., the first resolution) of the downsampled image. For example, the electronic device may determine the number of times that upsampling is performed, based on Equation 5 below.

$${N}_{up} = ceil ( {log}_{n} ( \frac{r e {s}_{original}}{r e {s}_{down}} ) ) \qquad [ Equation 5 ]$$

Nᵤₚ denotes the number of times that upsampling is performed; res_{original} denotes the resolution (Width×Height) of the original image 510; res_{down} denotes the resolution (e.g., a first resolution) of the downsampled image; ‘n’ denotes a specified multiple; and, ‘ceil’ denotes a rounding-up function. The electronic device may determine the resolution of each stepwise upsampling based on Equation 5. For example, the resolution (e.g., a second resolution) of the first-step upsampling may be res1=n*res_{down}; the resolution (e.g., a third resolution) of the second-step upsampling may be res2=n*res1; and, the resolution (e.g., the resolution of the original image 510) of the Nᵤₚ-step upsampling may be res_{Nup}=res_{original}.

According to an embodiment, in operation 503, the electronic device may generate a first intermediate image 530-1 by removing some components (e.g., a shadow image and/or a light reflection image) from the first image 520-1. For example, the electronic device may remove some components from the first image 520-1 by processing the first image 520-1 by using a trained artificial intelligence model. According to an embodiment, the electronic device may use the first intermediate image 530-1 for a specified operation. When the first intermediate image 530-1 satisfies the specified resolution corresponding to the specified operation, the electronic device may perform the specified operation based on the first intermediate image 530-1. For example, when the resolution of the first intermediate image 530-1 corresponds to the resolution of a thumbnail image, the electronic device may use the first intermediate image 530-1 as the thumbnail image.

According to an embodiment, in operation 505, the electronic device may generate a first difference image 540-1 based on the first image 520-1 and the first intermediate image 530-1. For example, the electronic device may generate the first difference image 540-1 by subtracting the first image 520-1 (e.g., each pixel value of the first image 520-1) from the first intermediate image 530-1 (e.g., each pixel value of the first intermediate image 530-1).

According to an embodiment, in operation 507, the electronic device may generate a second image 520-2 by downsampling the original image 510 so as to have a second resolution.

According to an embodiment, in operation 509, the electronic device may generate a second difference image 540-2 by upsampling the first difference image 540-1 so as to have a second resolution.

According to an embodiment, in operation 511, the electronic device may generate a second intermediate image 530-2 by combining the second image 520-2 and the second difference image 540-2. For example, when the second intermediate image 530-2 satisfies the specified resolution corresponding to the specified operation, the electronic device may perform the specified operation based on the second intermediate image 530-2. For example, when the resolution of the second intermediate image 530-2 corresponds to the resolution of a preview image, the electronic device may use the second intermediate image 530-2 as the preview image.

According to an embodiment, in operation 513, the electronic device may generate a third image 520-3 by downsampling the original image 510 so as to have a third resolution.

According to an embodiment, in operation 515, the electronic device may generate a third difference image 540-3 by upsampling the second difference image 540-2 so as to have a third resolution.

According to an embodiment, in operation 517, the electronic device may generate a third intermediate image 530-3 by combining the third image 520-3 and the third difference image 540-3. For example, when the third intermediate image 530-3 satisfies the specified resolution corresponding to the specified operation, the electronic device may perform the specified operation based on the third intermediate image 530-3. For example, when the resolution of the third intermediate image 530-3 corresponds to the resolution of an image (e.g., an image used in an image editing application) for editing, the electronic device may use the third intermediate image 530-3 as the image for editing.

According to an embodiment, in operation 519, the electronic device may generate a fourth difference image 540-5 by upsampling the third difference image 540-3 so as to have a resolution corresponding to the resolution of the original image 510.

According to an embodiment, in operation 521, the electronic device may generate a final image 550 by combining the original image 510 and the fourth difference image 540-5. The electronic device may store the final image 550 in a memory. According to an embodiment, at least some of the operations of FIG. 5 may be performed in background by a processor of the electronic device.

According to an embodiment, at least some of the operations of FIG. 5 may be performed, simultaneously or in a different order, and at least some operations (e.g., at least some operations (e.g., operation 511 and/or operation 517) that generate an intermediate image) may be omitted or new operations (e.g., operations of FIG. 2 or FIG. 3) may be added. For example, when there is no specified operation capable of being performed by using the second intermediate image 530-2 and/or the third intermediate image 530-3, the electronic device may omit operation 511 and/or operation 517 and may not generate the second intermediate image 530-2 and/or the third intermediate image 530-3.

According to an embodiment, the electronic device may upsample the difference image and may utilize the original image 510 when generating the final image 550, thereby reducing damage and loss of details of the original image 510 capable of occurring during upsampling. The electronic device may reduce image damage capable of occurring during upsampling by performing recursive upsampling, and may utilize the intermediate image generated during upsampling for a specified function and/or a specified operation.

FIG. 6 is a block diagram of an electronic device, according to an embodiment.

According to an embodiment, the electronic device 610 (e.g., the electronic device 100 of FIG. 1, the electronic device 700 of FIG. 7, or the electronic device 1001 of FIG. 10) may include the first image processing module 611 (e.g., the first image processing module 130 of FIG. 1, the first image processing module 702 of FIG. 7, or the processor 1020 of FIG. 10), the second image processing module 613 (e.g., the second image processing module 140 of FIG. 1, the second image processing module 704 of FIG. 7, or the processor 1020 of FIG. 10), a first display (e.g., the display 150 of FIG. 1 or the display module 1060 of FIG. 10), a first memory (e.g., the first memory 160 of FIG. 1 or the memory 1030 of FIG. 10), a controller (e.g., the controller 180 of FIG. 1, the controller 706 of FIG. 7, or the processor 1020 of FIG. 10), and a second memory (e.g., the second memory 170 of FIG. 1 or the volatile memory 1032 of FIG. 10).

The first image processing module 611 may receive an original image from an image input module 691. The first image processing module 611 may generate a first image by downsampling the original image. The first image processing module 611 may generate a second image by removing some components from the downsampled first image. According to an embodiment, some components may include a shadow image and/or a light reflection image. For example, the first image processing module 611 may remove some components from the first image by using the trained AI learning model (e.g., an image processing model trained through machine learning (e.g., deep learning)). The first image processing module 611 may generate a difference image based on the first image and the second image. For example, the first image processing module 611 may generate a difference image by subtracting a value of each of pixels of the corresponding first image from a value of each of the pixels of the second image. For example, the first image processing module 611 may generate the difference image by subtracting the value of each of the pixels of the second image from the value of each of the pixels of the first image and then inverting the values of the pixels (e.g., conversion to a value symmetrical to a reference value). The difference image may correspond to the removed components (e.g., the shadow image and/or the light reflection image). The first image processing module 611 may deliver the difference image to the second image processing module 613.

According to an embodiment, the second image processing module 613 may perform a stepwise upsampling operation based on information and/or commands received from the controller 618. For example, the second image processing module 613 may generate a final image of a resolution corresponding to the resolution of the original image by correcting (editing) the downsampled image and then stepwise upsampling the corrected image. The second image processing module 613 may perform upsampling based on information, which is received from the controller 618 and which is related to the number of times that stepwise upsampling is performed, whether to perform tiling, whether a tile image is padded/cropped, the number of tile images, and/or the size of the tile image. According to an embodiment, the second image processing module 613 may split the difference image (and the original image) into a plurality of first tile images. When a computational memory of a processor exceeds a predetermined threshold value, the second image processing module 613 may split the difference image into a plurality of tile images. The second image processing module 613 may stepwise upsample each of the tile images. The second image processing module 613 may not perform upsampling of a tile image satisfying a specified condition (e.g., a case where the sum of values of pixels of a tile image is 0). According to an embodiment, when the second image processing module 613 receives a command for performing tiling from the controller 618, the second image processing module 613 may split the difference image into a plurality of tile images. The second image processing module 613 may stepwise upsample each of the tile images. The second image processing module 613 may generate a difference image (a plurality of tile images corresponding to the difference image) having a resolution corresponding to the resolution of the original image as the result of stepwise upsampling. The second image processing module 613 may transmit the upsampled difference image to a third image processing module 693.

The first display 615 may display an image. For example, the first display 615 may display an original image, a downsampled image (e.g., a first image), a difference image, an intermediate image generated during stepwise upsampling, and/or a final image.

According to an embodiment, the first memory 617 may store instructions that control the operation of the electronic device 610 when executed by the processor. According to an embodiment, the first memory 617 may at least temporarily store an image. For example, the first memory 617 may store, at least temporarily, the original image, the downsampled image, the difference image, the intermediate image, and/or the final image. The first memory 617 may store information and/or data related to the operation of the electronic device 610.

According to an embodiment, the controller 618 may receive resolution information from the second image processing module 613. The resolution information may include the resolution of the original image and/or the resolution of the downsampled image (e.g., the first image and/or the removed image). The controller 618 may determine the number of times that stepwise upsampling is performed and/or whether to perform tiling, based on the resolution information. The controller 618 may transmit information about the determined number of times that stepwise upsampling is performed and/or whether to perform tiling, to the second image processing module 613.

According to an embodiment, the second memory 619 may store data for the calculation of the processor. For example, the second memory 619 may include the computational memory (e.g., RAM) of the processor. According to an embodiment, the first memory 617 and the second memory 619 may be implemented as one physical memory.

According to an embodiment, an external electronic device 690 (e.g., an external electronic device 790 of FIG. 7 or the electronic device 1002 or 1004 of FIG. 10) may include the image input module 691, the third image processing module 693, a second display 695, a third memory 697, and a user input module 699.

The image input module 691 may obtain an original image. For example, the image input module 691 may include a camera. The image input module 691 may capture the original image by using the camera. For example, the image input module 691 may include a communication circuit. The image input module 691 may receive the original image from an external device through the communication circuit. The image input module 691 may provide the original image to the first image processing module 611, the second image processing module 613, the third image processing module 693, and/or the controller 618.

The third image processing module 693 may generate a final image based on the original image and the upsampled difference image. The final image may be an image which has a resolution corresponding to the resolution of the original image, and in which some components are removed from the original image. For example, the third image processing module 693 may generate the final image by adding the difference image to the original image. When the third image processing module 693 receives a plurality of upsampled tile images from the second image processing module 613, the third image processing module 693 may split the original image into original tile images of which the number is the same as the number of upsampled tile images. The third image processing module 693 may generate a plurality of combined images by combining the original tile images with the corresponding upsampled tile images, respectively. The third image processing module 693 may generate the final image by composing the plurality of combined images.

The second display 695 may display an image. For example, the second display 695 may display an original image, a downsampled image (e.g., a first image), a difference image, an intermediate image generated during stepwise upsampling, and/or a final image.

According to an embodiment, the third memory 697 may store instructions that control the operation of the external electronic device 690 when executed by the processor. According to an embodiment, the third memory 697 may at least temporarily store an image. For example, the third memory 697 may store, at least temporarily, the original image, the downsampled image, the difference image, the intermediate image, and/or the final image. The third memory 697 may store information and/or data related to the operation of the external electronic device 690.

According to an embodiment, the user input module 699 may receive a user input. The user input module 699 may receive a user input for selecting an original image for correction from among images stored in the external electronic device 690 (e.g., the third memory 697). The user input module 120 may receive, from a user, an input for selecting the original image, an input for editing an image, and/or an input for displaying an image (e.g., an original image, a difference image, an intermediate image generated during stepwise upsampling, and/or a final image). The user input module 699 may provide the user input to the image input module 691 and/or the controller 618.

According to various embodiments, operations of the electronic device 610 and the external electronic device 690 are not limited to that illustrated in FIG. 6, and the electronic device 610 and the external electronic device 690 may perform at least some of the operations described in FIGS. 1, 2, 4, and 5. For example, the electronic device 610 and the external electronic device 690 may distribute and perform a series of operations of generating a final image by correcting an original image based on the performance of each device. For example, each of the electronic device 610 (e.g., the first image processing module 611 and/or the second image processing module 613) and the external electronic device 690 (e.g., the third image processing module 693) may separately perform at least some steps of the stepwise upsampling operation. For example, the third image processing module 693 of the external electronic device 690 may perform an operation of generating a removed image or a difference image, and the first image processing module 611 and/or the second image processing module 613 may perform a stepwise upsampling operation. For example, the electronic device 610 may not perform the stepwise upsampling operation, but the external electronic device 690 may perform the stepwise upsampling operation.

According to various embodiments, configurations of the electronic device 610 and the external electronic device 690 are not limited to that illustrated in FIG. 6. Some configurations of each of the electronic device 610 and the external electronic device 690 may be omitted or at least one configuration thereof may be added.

According to an embodiment, the electronic device 610 may distribute a processing load and may perform image processing efficiently in consideration of the performance of a device, by correcting an original image through stepwise upsampling in conjunction with the external electronic device 690. According to an embodiment, the first image processing module 611, the second image processing module 613, the third image processing module 693 and/or the controller 618 may be implemented as at least one hardware module and may be implemented as at least one software module so as to be executed by at least one processor (not shown) (e.g., the processor 1020 of FIG. 10) of an electronic device and/or an external electronic device.

FIG. 7 is a diagram for describing an operation of an electronic device, according to an embodiment. Hereinafter, portions overlapping descriptions of FIG. 6 are briefly given or omitted.

According to an embodiment, the electronic device 700 (e.g., the electronic device 100 of FIG. 1, the electronic device 610 of FIG. 6, or the electronic device 1001 of FIG. 10) may include the first image processing module 702 (e.g., the first image processing module 130 of FIG. 1 or the first image processing module 611 of FIG. 6), the second image processing module 704 (e.g., the second image processing module 140 of FIG. 1 or the second image processing module 613 of FIG. 6), and the controller 706 (e.g., the controller 180 of FIG. 1 or the controller 618 of FIG. 6). The external electronic device 790 (e.g., the external electronic device 690 of FIG. 6 or the electronic device 1002 or 1004 of FIG. 10) may include a user input module 792, an app/display 794, and a third image processing module 796.

According to an embodiment, in operation 701, the user input module 792 may deliver an original image selection input to the app/display 794. For example, the user input module 792 may receive a user input for selecting an original image to be corrected from among pre-stored images.

According to an embodiment, in operation 703, the app/display 794 may transmit the original image to the first image processing module 702 in response to the original image selection input.

According to an embodiment, in operation 705, the first image processing module 702 may generate a first image by downsampling the original image. The first image processing module 702 may generate a removed image by removing some components (e.g., a shadow image and/or a light reflection image) from the first image. The first image processing module 702 may remove some components from the first image by using a trained artificial intelligence learning model. The first image processing module 702 may deliver the removed image to the second image processing module 704.

According to an embodiment, in operation 707, the second image processing module 704 may provide resolution information to the controller 706 based on the removed image. The resolution information may include the resolution of the original image and/or the resolution of the downsampled image (e.g., the first image and/or the removed image).

According to an embodiment, in operation 709, the controller 706 may determine the number of times that stepwise upsampling is performed and/or whether to perform tiling, based on the resolution information. The controller 706 may transmit information about the determined number of times that stepwise upsampling is performed and/or whether to perform tiling, to the second image processing module 704.

According to an embodiment, in operation 711, the second image processing module 704 may perform stepwise upsampling based on information received from the controller 706. For example, the second image processing module 704 may generate a difference image based on the first image and the removed image. For example, the second image processing module 704 may generate a difference image by subtracting the first image from the removed image. The second image processing module 704 may stepwise upsample the difference image. According to an embodiment, when the second image processing module 704 receives a command for performing tiling from the controller 706, the second image processing module 704 may split the difference image into a plurality of tile images. The second image processing module 704 may stepwise upsample each of the tile images. The second image processing module 704 may generate a difference image (a plurality of tile images corresponding to the difference image) having a resolution corresponding to the resolution of the original image as the result of stepwise upsampling.

According to an embodiment, in operation 713, the second image processing module 704 may transmit the upsampled difference image to the third image processing module 796.

According to an embodiment, in operation 715, the third image processing module 796 may generate a final image based on the original image and the upsampled difference image. The final image may be an image which has a resolution corresponding to the resolution of the original image, and in which some components are removed from the original image. For example, the third image processing module 796 may generate the final image by adding the difference image to the original image. When the third image processing module 796 receives a plurality of upsampled tile images from the second image processing module 704, the third image processing module 693 may split the original image into original tile images of which the number is the same as the number of upsampled tile images. The third image processing module 796 may generate a plurality of combined images by combining the original tile images with the corresponding upsampled tile images, respectively. The third image processing module 796 may generate the final image by composing the plurality of combined images. The third image processing module 796 may deliver the final image to the app/display 794. The app/display 794 may store and/or output the final image.

According to various embodiments, operations of the electronic device 700 and the external electronic device 790 are not limited to that illustrated in FIG. 7, and the electronic device 700 and the external electronic device 790 may perform at least some of the operations described in FIGS. 1, 2, 4, and 5. For example, each of the electronic device 700 (e.g., the first image processing module 702 and/or the second image processing module 704) and the external electronic device 790 (e.g., the third image processing module 796) may separately perform at least some steps of the stepwise upsampling operation. For example, the electronic device 700 may deliver an intermediate image generated during stepwise upsampling to the external electronic device 790, and the external electronic device 790 may perform stepwise upsampling based on the received intermediate image. For example, the third image processing module 796 of the external electronic device 790 may perform operation 705, and the first image processing module 702 and/or the second image processing module 704 may perform operation 711. For example, the electronic device 700 may not perform operation 711, but the external electronic device 790 may perform operation 711.

According to various embodiments, configurations of the electronic device 700 and the external electronic device 790 are not limited to that illustrated in FIG. 6. Some configurations of each of the electronic device 700 and the external electronic device 790 may be omitted or at least one configuration thereof may be added.

According to an embodiment, the electronic device 700 may distribute a processing load and may perform image processing efficiently in consideration of the performance of a device, by correcting an original image through stepwise upsampling in conjunction with the external electronic device 790.

When the resolution of an image is changed, details of the image may be lost or the image may be damaged. Various embodiments of the disclosure aim to provide an electronic device capable of removing unwanted components included in an image, and an image processing method of the electronic device. Various embodiments of the disclosure aim to provide an electronic device capable of minimizing or reducing loss and damage of an image when the resolution of the image is changed, and an image processing method of the electronic device. The technical problems to be solved in this specification are not limited to the aforementioned problem, and other technical problems that are not mentioned will be clearly understood by those skilled in the art, to which the disclosure pertains, from the following description.

According to an embodiment, an electronic device may include a communication circuit, a memory, and a processor. According to an embodiment, the processor may be configured to generate a first image by downsampling an original image. According to an embodiment, the processor may be configured to generate a second image by removing a partial component included in the first image from the first image. According to an embodiment, the processor may be configured to generate a difference image between the first image and the second image. According to an embodiment, the processor may be configured to determine the number of times that the difference image is stepwise upsampled to have a resolution corresponding to the resolution of the original image. According to an embodiment, the processor may be configured to generate an upsampled difference image by stepwise upsampling the difference image the determined number of times. According to an embodiment, the processor may be configured to generate a final image, which corresponds to a resolution of the original image and in which the partial component is removed from the original image, based on the original image and the upsampled difference image. According to an embodiment, the processor may be configured to store the final image in the memory.

According to an embodiment, the processor may be configured to recognize whether the computational memory of the processor exceeds a predetermined threshold value. According to an embodiment, the processor may be configured to split the difference image into a plurality of tile images when the computational memory exceeds the threshold value. According to an embodiment, the processor may be configured to stepwise upsample the plurality of tile images the determined number of times. According to an embodiment, the processor may be configured to generate the final image based on the original image and the upsampled plurality of tile images.

According to an embodiment, the processor may be configured to add padding to edges of the plurality of tile images. According to an embodiment, the processor may be configured to stepwise upsample the padding-added plurality of tile images. According to an embodiment, the processor may be configured to crop the upsampled padding-added plurality of tile images. According to an embodiment, the processor may be configured to generate the final image based on the original image and the cropped plurality of tile images. According to an embodiment, the processor may be configured to generate an intermediate original image by downsampling an original image to have a resolution corresponding to an intermediate difference image upsampled by a number of times less than the determined number of times while stepwise upsampling the difference image. According to an embodiment, the processor may be configured to generate an intermediate result image based on the intermediate difference image and the intermediate original image. According to an embodiment, the processor may be configured to recognize whether the generated intermediate result image corresponds to a specified resolution. According to an embodiment, the processor may be configured to perform a specified operation based on the intermediate result image when the intermediate result image corresponds to the specified resolution.

According to an embodiment, the specified operation may include an operation of providing the intermediate result image as an image for editing.

According to an embodiment, the electronic device may include a display. According to an embodiment, the specified resolution may include a resolution of a specified preview image. According to an embodiment, the specified operation may include an operation of outputting the intermediate result image as the preview image through the display.

According to an embodiment, the electronic device may include a camera. According to an embodiment, the processor may be configured to obtain the original image through the camera.

According to an embodiment, the processor may be configured to obtain the original image from an external electronic device through the communication circuit.

According to an embodiment, the processor may be configured to determine the number of times based on a ratio between a resolution of the original image and a resolution of the first image, and a specified upsampling magnification.

According to an embodiment, the processor may be configured to request an external electronic device to perform at least some of a stepwise upsampling operation the determined number of times. According to an embodiment, the processor may be configured to receive a result of performing at least some of the stepwise upsampling operation the determined number of times from the external electronic device.

According to an embodiment, the processor may be configured to remove the partial component included in the first image from the first image by using a trained artificial intelligence learning model.

According to an embodiment, the partial component may include at least one of a shadow image and a light reflection image that are included in the first image.

According to embodiments disclosed in the specification, unwanted components included in an image may be removed. According to embodiments disclosed in the specification, the time, resources, and computational amount consumed for image correction may be reduced. According to embodiments disclosed in the specification, the loss and damage of an image may be minimized or reduced when a resolution of the image is changed. Besides, a variety of effects directly or indirectly understood through the disclosure may be provided. Effects obtained in the disclosure are not limited to the above-mentioned effects, and other effects that are not mentioned will be clearly understood by those skilled in the art, to which the disclosure belongs, from the following description.

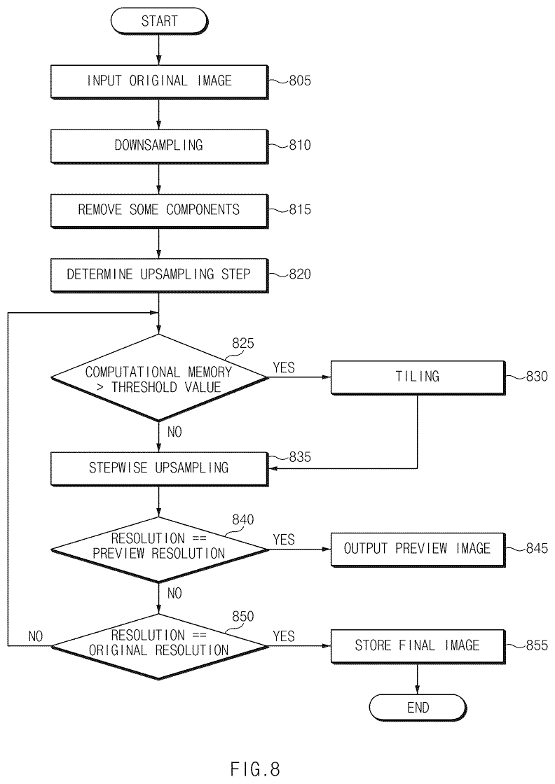

FIG. 8 is a flowchart of an image processing method of an electronic device, according to an embodiment.

According to an embodiment, in operation 805, an electronic device (e.g., the electronic device 100 of FIG. 1, the electronic device 610 of FIG. 6, the electronic device 700 of FIG. 7, or the electronic device 1001 of FIG. 10) (e.g., a processor (e.g., the controller 180 of FIG. 1, the controller 618 of FIG. 6, the controller 706 of FIG. 7, or the processor 1020 of FIG. 10) of the electronic device) may receive an original image. For example, the electronic device may capture the original image by using a camera, or may receive the original image from an external device. The electronic device may select (or determine) at least one original image from among images previously stored in a memory of the electronic device based on a user input.

According to an embodiment, in operation 810, the electronic device (e.g., a processor of the electronic device) may downsample the original image. The electronic device may generate a first image by downsampling the original image so as to have a specified resolution.

According to an embodiment, in operation 815, the electronic device (e.g., the processor of the electronic device) may generate a second image by removing some components (e.g., a shadow image and/or a light reflection image) from the first image. The electronic device may generate the second image by removing some components from the first image by using a trained artificial intelligence learning model (e.g., a machine learning (e.g., deep learning) model). The electronic device may generate a difference image based on the original image and the second image. The difference image may correspond to the removed components (e.g., the shadow image and/or the light reflection image). For example, an electronic device may generate the difference image by subtracting the first image (e.g., each pixel value of the first image) from the second image (e.g., each pixel value of the second image).

According to an embodiment, in operation 820, the electronic device (e.g., the processor of the electronic device) may determine an upsampling step. The electronic device may determine the number of times that stepwise upsampling is performed. The electronic device may determine the number of times that stepwise upsampling is performed, based on a specified upsampling multiple, the resolution of the original image, and the resolution of the downsampled image (e.g., the first image). According to an embodiment, the specified multiple may vary based on the state of the electronic device, the user input, the resolution of the original image, and/or the resolution of the downsampled image.

According to an embodiment, in operation 825, the electronic device (e.g., the processor of the electronic device) may determine whether a computational memory of the processor exceeds a threshold value. The electronic device may determine whether to perform tiling based on whether the amount of computation (e.g., an operational memory) of the processor exceeds the threshold value. The electronic device may perform operation 830 when the computational memory exceeds the threshold value. The electronic device may skip operation 830 and may perform operation 835 when the computational memory is less than or equal to the threshold value.

According to an embodiment, in operation 830, the electronic device (e.g., the processor of the electronic device) may split the original image and the difference image into a plurality of tile images. The electronic device may determine the number and/or sizes of tile images based on the resolution of the original image and the resolution of the first image (alternatively, the second image or the difference image).

According to an embodiment, in operation 835, the electronic device (e.g., the processor of the electronic device) may perform stepwise upsampling. The electronic device may upsample the difference image multiple times based on the specified upsampling multiple. For example, when the difference image is split into the plurality of tiles in operation 830, the electronic device may perform stepwise upsampling on each of the split tile images. The electronic device may generate an intermediate image and/or a final image by combining the original image and the difference image having a resolution corresponding to each upsampling step. For example, when the difference image is split into the plurality of tile images, the electronic device may generate the intermediate image and/or the final image by splitting the original image into a plurality of original tile images, of which the number is the same as the number of tile images, and combining the tile images corresponding to each other. According to an embodiment, to prevent or reduce image damage at a boundary of a tile image, the electronic device may add padding to each direction of the tile image and may crop an area corresponding to the padding after upsampling the tile image.

According to an embodiment, in operation 840, the electronic device (e.g., the processor of the electronic device) may determine whether a resolution of an intermediate image generated during the stepwise upscaling corresponds to a specified resolution. The intermediate image may refer to an image generated at each stage of stepwise upsampling before generating the final image. For example, the electronic device may determine whether the resolution of the intermediate image corresponds to the resolution of the preview image. When the resolution of the intermediate image corresponds to the specified resolution, the electronic device may perform operation 845. When the resolution of the intermediate image does not correspond to the specified resolution, the electronic device may perform operation 850. For example, in FIG. 8, the specified operation is described as outputting a preview image, but is not limited thereto. The specified operation may include various operations (e.g., editing an image and/or outputting a thumbnail image) capable of being performed by the electronic device.

According to an embodiment, in operation 845, the electronic device (e.g., the processor of the electronic device) may perform the specified operation based on the intermediate image. For example, the electronic device may output the intermediate image as a preview image.

According to an embodiment, in operation 850, the electronic device (e.g., the processor of the electronic device) may determine whether the resolution of the generated image corresponds to the resolution of the original image. For example, the electronic device may determine whether to generate a final image with a desired resolution (e.g., the resolution of the original image) as the result of performing stepwise upscaling. When the resolution of the generated image corresponds to the resolution of the original image, the electronic device may perform operation 855. When the resolution of the generated image does not correspond to the resolution of the original image, the electronic device may repeatedly perform stepwise upscaling operations following operation 825.

According to an embodiment, in operation 855, the electronic device (e.g., the processor of the electronic device) may store the final image in a memory.

According to various embodiments, the order of the operations in FIG. 8 may be changed, and at least some of the operations may be performed simultaneously. At least some (e.g., operation 840 and operation 845) of the operations of FIG. 8 may be skipped, and at least one operation (e.g., at least one of the operations of FIGS. 2, 4, 5, and/or 10) may be added.

According to an embodiment, the electronic device may reduce the damage and loss of details of the original image capable of being generated during upsampling by upsampling the difference image and utilizing the original image when the final image is generated. The electronic device may reduce the amount of computation (e.g., operating memory consumption) and image processing time of the processor by tiling an original image and a difference image and upsampling and/or compositing the tiled result. The electronic device may prevent or reduce chances of an image from being damaged at a border of a tile image by applying padding and cropping to the tile image. The electronic device may reduce image damage capable of occurring during upsampling by performing recursive upsampling, and may utilize the intermediate image generated during upsampling for a specified function and/or a specified operation.

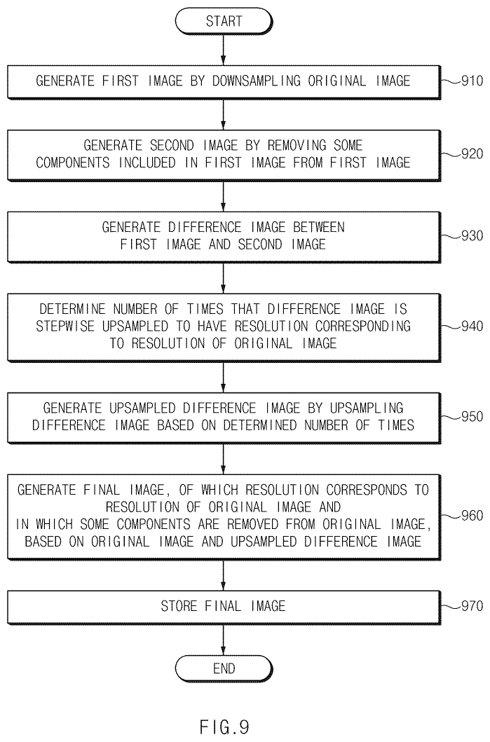

FIG. 9 is a flowchart of an image processing method of an electronic device, according to an embodiment.

According to an embodiment, in operation 910, an electronic device (e.g., the electronic device 100 of FIG. 1, the electronic device 610 of FIG. 6, the electronic device 700 of FIG. 7, or the electronic device 1001 of FIG. 10) (e.g., a processor (e.g., the controller 180 of FIG. 1, the controller 618 of FIG. 6, the controller 706 of FIG. 7, or the processor 1020 of FIG. 10) of the electronic device) may generate a first image by downsampling an original image. For example, the electronic device may generate the first image by lowering the resolution of the original image.

According to an embodiment, in operation 920, the electronic device (e.g., a processor of the electronic device) may generate a second image by removing some components (e.g., a shadow image and/or a light reflection image) included in the first image from the first image. For example, the electronic device may remove some components from the first image based on the trained artificial intelligence model.

According to an embodiment, in operation 930, the electronic device (e.g., the processor of the electronic device) may generate a difference image between the first image and the second image. For example, the electronic device may generate a difference image by subtracting a value of each of pixels of the corresponding first image from a value of each of pixels of the second image. For example, the electronic device may generate the difference image by subtracting the value of each of the pixels of the second image from the value of each of the pixels of the first image and then inverting the values of the pixels (e.g., conversion to a value symmetrical to a reference value).

According to an embodiment, in operation 940, the electronic device (e.g., the processor of the electronic device) may determine the number of times that the difference image is stepwise upsampled to have a resolution corresponding to the resolution of the original image. The electronic device may determine the number of times that stepwise upsampling is performed, based on a specified upsampling (resolution) multiple (e.g., ‘n’ times), the resolution of the original image, and the resolution (e.g., a first resolution) of the downsampled image.

According to an embodiment, in operation 950, the electronic device (e.g., the processor of the electronic device) may generate an upsampled difference image by upsampling the difference image based on the determined number of times. For example, the electronic device may upsample the difference image by using a joint up-sampling method. The electronic device may finally generate an upsampled difference image having a resolution corresponding to the resolution of the original image through stepwise upsampling. According to an embodiment, the electronic device may split the difference image (and the original image) into a plurality of first tile images. For example, the electronic device may recognize whether the computational memory (or an operating memory) of a processor exceeds a predetermined threshold value. The electronic device may recognize whether OOM occurs. When a computational memory of a processor exceeds a predetermined threshold value, the electronic device may split the difference image into a plurality of tile images. When the computational memory of the processor does not exceed the predetermined threshold value, the electronic device may not split the difference image (and the original image) into a plurality of tile images. For example, the electronic device may determine the number and/or sizes of tiles under the condition that the operating memory of the processor does not exceed a specified free memory. For example, the electronic device may determine the number and/or sizes of tiles based on the resolution of the original image and/or the output resolution (e.g., a downsampling resolution) of the AI learning model used to remove components. For example, the electronic device may determine the number of tile images as one of divisors of the resolution of the model output (e.g., the downsampled first image). The electronic device may stepwise upsample each of the tile images. The electronic device may not perform upsampling of a tile image satisfying a specified condition (e.g., a case where the sum of values of pixels of a tile image is 0). In this case, in operation 960, the electronic device may generate the final image by using the corresponding original tile image instead of the tile image.

According to an embodiment, the electronic device may recognize the resolution of an intermediate image generated during stepwise upsampling. When the resolution of the intermediate image corresponds to a specified resolution (e.g., an image resolution for thumbnail, an image resolution for preview, and/or an image resolution for editing), the electronic device may perform the specified operation and/or the specified function (e.g., outputting a thumbnail image, outputting a preview image, and/or editing an image) based on the intermediate image.

According to an embodiment, in operation 960, the electronic device (e.g., the processor of the electronic device) may generate the final image, of which the resolution corresponds to the resolution of the original image and in which some components are removed from the original image, based on the original image and the upsampled difference image. For example, the electronic device may generate the final image by adding the upsampled difference image to the original image. For example, the electronic device may generate the final image by adding a value of each pixel of the upsampled difference image to a value of each pixel of the original image.

According to an embodiment, in operation 970, the electronic device (e.g., the processor of the electronic device) may store the final image in a memory.

According to various embodiments, the order of the operations in FIG. 9 may be changed, and at least some of the operations may be performed simultaneously. At least some (e.g., operation 840 and operation 845) of the operations of FIG. 8 may be skipped, and at least one operation (e.g., at least one of the operations of FIGS. 2, 4, 5, and/or 9) may be added.

According to an embodiment, the electronic device 100 may reduce the damage and loss of details of the original image capable of being generated during upsampling by upsampling the difference image and utilizing the original image when the final image is generated. The electronic device 100 may reduce the amount of computation (e.g., operating memory consumption) and image processing time of the processor by tiling an original image and a difference image and upsampling and/or compositing the tiled result. The electronic device 100 may prevent or reduce chances of an image from being damaged at a border of a tile image by applying padding and cropping to the tile image. The electronic device 100 may reduce image damage capable of occurring during upsampling by performing recursive upsampling, and may utilize the intermediate image generated during upsampling for a specified function and/or a specified operation.

A method for image processing of an electronic device according to an embodiment may include an operation of generating a first image by downsampling an original image. According to an embodiment, the method may include an operation of generating a second image by removing a partial component included in the first image from the first image. According to an embodiment, the method may include an operation of generating a difference image between the first image and the second image; According to an embodiment, the method may include an operation of determining the number of times that the difference image is stepwise upsampled to have a resolution corresponding to a resolution of the original image. According to an embodiment, the method may include an operation of generating an upsampled difference image by stepwise upsampling the difference image the determined number of times. According to an embodiment, the method may include an operation of generating a final image, which corresponds to a resolution of the original image and in which the partial component is removed from the original image, based on the original image and the upsampled difference image. According to an embodiment, the method may include an operation of storing the final image.

According to an embodiment, the generating of the final image may include recognizing whether a computational memory of a processor of the electronic device exceeds a predetermined threshold value. According to an embodiment, the generating of the final image may include splitting the difference image into a plurality of tile images when the computational memory exceeds the threshold value. According to an embodiment, the generating of the final image may include stepwise upsampling the plurality of tile images the determined number of times. According to an embodiment, the generating of the final image may include generating the final image based on the original image and the upsampled plurality of tile images.

According to an embodiment, the method may include generating an intermediate original image by downsampling an original image so as to have a resolution corresponding to an intermediate difference image upsampled by a number of times less than the determined number of times while stepwise upsampling the difference image. According to an embodiment, the method may include generating an intermediate result image based on the intermediate difference image and the intermediate original image; According to an embodiment, the method may include recognizing whether the generated intermediate result image corresponds to a specified resolution. According to an embodiment, the method may include performing a specified operation based on the intermediate result image when the intermediate result image corresponds to the specified resolution.

According to an embodiment, the performing of the specified operation may include at least one of providing the intermediate result image as an image for editing and outputting the intermediate result image as a preview image.

According to an embodiment, the determining of the number of times may include determining the number of times based on a ratio between the resolution of the original image and a resolution of the first image, and a specified upsampling magnification. “Based on” as used herein covers based at least on.

According to an embodiment, the generating of the second image may include removing the partial component included in the first image from a first image by using a trained artificial intelligence learning model.

According to an embodiment, the partial component may include at least one of a shadow image and a light reflection image that are included in the first image.

A recording medium according to an embodiment may store a program (or instructions) that, when executed by a processor of an electronic device, causes the electronic device to perform the image processing method.

According to embodiments disclosed in the specification, unwanted components included in an image may be removed. According to embodiments disclosed in the specification, the time, resources, and computational amount consumed for image correction may be reduced. According to embodiments disclosed in the specification, the loss and damage of an image may be minimized or reduced when a resolution of the image is changed. Besides, a variety of effects directly or indirectly understood through the disclosure may be provided. Effects obtained in the disclosure are not limited to the above-mentioned effects, and other effects that are not mentioned will be clearly understood by those skilled in the art, to which the disclosure belongs, from the following description.

FIG. 10 is a block diagram of an electronic device 1001 in a network environment 1000, according to various embodiments. Referring to FIG. 1, the electronic device 1001 in the environment information 1000 may communicate with an electronic device 1002 over a first network 1098 (e.g., a short range wireless communication network) or may communicate with at least one of an electronic device 1004 or a server 1008 over a second network 1099 (e.g., a long distance wireless communication network). According to an embodiment, the electronic device 1001 may communicate with the electronic device 1004 through the server 1008. According to an embodiment, the electronic device 1001 may include a processor 1020, a memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module 1096, or an antenna module 1097. In any embodiment, the electronic device 1001 may not include at least one (e.g., the connecting terminal 1078) of the above-described components or may further include one or more other components. In some embodiments, some (e.g., the sensor module 1076, the camera module 1080, or the antenna module 1097) of these components may be integrated into a single component (e.g., the display module 1060).

For example, the processor 1020 may execute software (e.g., a program 1040) to control at least another component (e.g., hardware or software component) of the electronic device 1001 connected to the processor 1020, and may process and calculate various types of data. According to an embodiment, as at least part of data processing or calculation, the processor 1020 may store instructions or data received from other components (e.g., the sensor module 1076 or the communication module 1090 comprising communication circuitry) into a volatile memory 1032, may process instructions or data stored in the volatile memory 1032, and may store the result data in a nonvolatile memory 1034. According to an embodiment, the processor 1020 may include a main processor 1021 (e.g., a central processing unit or an application processor) and an auxiliary processor 1023 (e.g., a graphic processing unit, a neural processing unit (NPU), an image signal processor, a sensor hub processor, or a communication processor) capable of operating independently or together with the main processor. For example, when the electronic device 1001 includes the main processor 1021 and the auxiliary processor 1023, the auxiliary processor 1023 may be configured to use less power than the main processor 1021 or to be specialized for a specified function. The auxiliary processor 1023 may be implemented separately from the main processor 1021 or as part of the main processor 121.

For example, the auxiliary processor 1023 may control at least part of the functions or states associated with at least one (e.g., the display module 1060, the sensor module 1076, or the communication module 1090) of the components of the electronic device 1001, instead of the main processor 1021 while the main processor 1021 is in an inactive (e.g., sleep) state or together with the main processor 1021 while the main processor 1021 is in an active (e.g., the execution of an application) state. According to an embodiment, the auxiliary processor 1023 (e.g., an image signal processor or a communication processor) may be implemented as a part of operatively associated other components (e.g., the camera module 1080 or the communication module 1090). According to an embodiment, the auxiliary processor 1023 (e.g., a neural network processing unit) may include a hardware structure specialized to process an artificial intelligence model. The artificial intelligence model may be generated through machine learning. For example, the learning may be performed in the electronic device 1001, in which an artificial intelligence model is performed, or may be performed through a separate server (e.g., the server 1008). For example, the learning algorithm may include supervised learning, unsupervised learning, semi-supervised learning, or reinforcement learning, but is not limited to the above example. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure.

The memory 1030 may store various pieces of data used by at least one component (e.g., the processor 1020 or the sensor module 1076) of the electronic device 1001. For example, data may include software (e.g., the program 1040) and input data or output data for instructions associated with the software. The memory 1030 may include the volatile memory 1032 or the nonvolatile memory 1034.

The program 1040 may be stored in the memory 1030 as software, and may include, for example, an operating system 1042, a middleware 1044, or an application 1046.

The input module 1050 may receive instructions or data to be used for the component (e.g., the processor 1020) of electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output a sound signal to the outside of the electronic device 1001. The sound output module 1055 may include, for example, a speaker or a receiver. The speaker may be used for a general purpose, such as multimedia play or recording play. The receiver may be used to receive an incoming call. According to an embodiment, the receiver may be implemented separately from the speaker or may be implemented as a part of the speaker.

The display module 1060 may visually provide information to the outside (e.g., the user) of the electronic device 1001. The display module 1060 may include, for example, a display, a hologram device, or a control circuit for controlling a projector and a corresponding device. According to an embodiment, the display module 1060 may include a touch sensor configured to sense a touch, or a pressure sensor configured to measure the strength of force generated by the touch.

The audio module 1070 may convert sound to an electrical signal, or reversely, may convert an electrical signal to sound. According to an embodiment, the audio module 1070 may obtain sound through the input module 1050, or may output sound through the sound output module 1055, or through an external electronic device (e.g., the electronic device 1002) (e.g., a speaker or a headphone) directly or wirelessly connected with the electronic device 1001.

The sensor module 1076 may sense an operation state (e.g., power or a temperature) of the electronic device 1001 or an external environment state (e.g., a user state), and may generate an electrical signal or a data value corresponding the sensed state. According to an embodiment, the sensor module 1076 may include, for example, a gesture sensor, a grip sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The interface 1077 may support one or more specified protocols that may be used to directly and wirelessly connect the electronic device 1001 with an external electronic device (e.g., the electronic device 1002). According to an embodiment, the interface 1077 may include, for example, a high definition multimedia interface (HDMI), a universal serial bus (USB) interface, a secure digital (SD) card interface, or an audio interface.

The connecting terminal 1078 may include a connector that may allow the electronic device 1001 to be physically connected with an external electronic device (e.g., the electronic device 1002). According to an embodiment, the connecting terminal 1078 may include, for example, a HDMI connector, an USB connector, an SD card connector, or an audio connector (e.g., a headphone connector).

The haptic module 1079 may convert an electrical signal to a mechanical stimulation (e.g., vibration or movement) or an electrical stimulation which the user may perceive through the sense of touch or the sense of movement. According to an embodiment, the haptic module 1079 may include, for example, a motor, a piezoelectric sensor, or an electrical stimulation device.

The camera module 1080 may shoot a still image or a video image. According to an embodiment, the camera module 1080 may include one or more lenses, image sensors, image signal processors, or flashes (or electrical flashes).

The power management module 1088 may manage the power which is supplied to the electronic device 1001. According to an embodiment, the power management module 1088 may be implemented, for example, as at least part of a power management integrated circuit (PMIC).

The battery 1089 may power at least one component of the electronic device 1001. According to an embodiment, the battery 1089 may include, for example, a primary cell not recharged, a secondary cell rechargeable, or a fuel cell.

The communication module 1090 may establish a direct (or wired) communication channel or a wireless communication channel between the electronic device 1001 and an external electronic device (e.g., the electronic device 1002, the electronic device 1004, or the server 1008) and may perform communication through the established communication channel. The communication module 1090 may include one or more communication processors which are operated independently of the processor 1020 (e.g., an application processor) and support direct (or wired) communication or wireless communication. According to an embodiment, the communication module 1090 may include a wireless communication module 1092 (e.g., a cellular communication module, a short range wireless communication module, or a global navigation satellite system (GNSS) communication module) or a wired communication module 1094 (e.g., a local area network (LAN) communication module or a power line communication module). The corresponding communication module among these communication modules may communicate with an external electronic device 1004 through a first network 1098 (e.g., a short-range communication network such as Bluetooth, wireless fidelity (WiFi) direct or infrared data association (IrDA)) or a second network 1099 (e.g., long-range wireless communication network such as a legacy cellular network, 5G networks, next-generation communication networks, Internet, or computer networks (e.g., LAN or WAN)). The above-described kinds of communication modules may be integrated in one component (e.g., a single chip) or may be implemented with a plurality of components (e.g., a plurality of chips) which are independent of each other. The wireless communication module 1092 may identify or authenticate the electronic device 1001 within a communication network, such as the first network 1098 or the second network 1099, by using subscriber information (e.g., international mobile subscriber identity (IMSI)) stored in the subscriber identification module 1096.

The wireless communication module 1092, comprising communication circuitry, may support a 5G network and a next-generation communication technology after a 4G network, for example, a new radio (NR) access technology. The NR access technology may support enhanced mobile broadband (eMBB), massive machine type communications (mMTC), or ultra-reliable and low-latency communications (URLLC). For example, the wireless communication module 1092 may support a high frequency band (e.g., mmWave band) to achieve a high data transfer rate. The wireless communication module 1092 may support various technologies for securing performance in a high frequency band, for example, technologies such as beamforming, massive multiple-input and multiple-output (massive MIMO), full dimensional MIMO (FD-MIMO), an array antenna, analog beam-forming, and a large scale antenna. The wireless communication module 1092 may support various requirements regulated in the electronic device 1001, an external electronic device (e.g., the electronic device 1004) or a network system (e.g., the second network 1099). According to an embodiment, the wireless communication module 1092 may support peak data rate (e.g., 20 Gbps or more) for eMBB implementation, loss coverage (e.g., 164 dB or less) for mMTC implementation, or U-plane latency (e.g., downlink (DL) of 0.5 ms or less and uplink (UL) of 0.5 ms or less, or round trip of 1 ms or less) for URLLC implementation.

The antenna module 1097 may transmit a signal or a power to the outside (e.g., an external electronic device) or may receive a signal or a power from the outside. According to an embodiment, the antenna module 1097 may include an antenna including a radiator formed of a conductor or a conductive pattern formed on a substrate (e.g., PCB). According to an embodiment, the antenna module 1097 may include a plurality of antennas (e.g., an array antenna). In this case, at least one antenna suitable for a communication scheme used in a communication network such as the first network 1098 or the second network 1099 may be selected, for example, by the communication module 1090 from the plurality of antennas. The signal or power may be exchanged between the communication module 1090 and an external electronic device through the selected at least one antenna or may be received from the external electronic device through the selected at least one antenna and the communication module 190. According to some embodiments, other parts (e.g., radio frequency integrated circuit (RFIC)) may be additionally formed as a part of the antenna module 1097 in addition to the radiator.

According to various embodiments, the antenna module 1097 may form an mmWave antenna module. According to an embodiment, the mmWave antenna module may include a printed circuit board (PCB), a radio frequency integrated circuit (RFIC), and a plurality of antennas (e.g., an array antenna). The RFIC may be disposed on or adjacent to a first surface (e.g., a bottom surface) of the PCB and may support a specified high frequency band (e.g., mm Wave band). The plurality of antennas may be disposed on or adjacent to a second surface (e.g., a top surface or a side surface) of the PCB and may transmit or receive a signal in the specified high frequency band.

At least some of the components may be connected, directly or indirectly, to each other through a communication scheme (e.g., a bus, a general purpose input and output (GPIO), a serial peripheral interface (SPI), or a mobile industry processor interface (MIPI)) between peripheral devices and may exchange signals (e.g., commands or data) with each other.

According to an embodiment, the command or data may be transmitted or received between the electronic device 1001 and the external electronic device 1004 through the server 1008 connected, directly or indirectly, to the second network 1099. Each of the external electronic device 1002 or 104 may be a device of which the type is the same as or different from that of the electronic device 1001. According to an embodiment, all or a part of operations to be executed by the electronic device 1001 may be executed in one or more external electronic devices among the external electronic devices 1002, 104, or 108. For example, when the electronic device 1001 needs to perform any function or service automatically or in response to a request from the user or any other device, the electronic device 1001 may additionally request one or more external electronic devices to perform at least part of the function or service, instead of internally executing the function or service. The one or more external electronic devices which receive the request may execute at least a part of the function or service thus requested or an additional function or service associated with the request, and may provide a result of the execution to the electronic device 1001. The electronic device 1001 may process received result as it is or additionally, and may provide a result of the processing as at least a part of the response to the request. To this end, for example, cloud computing, distributed computing, mobile edge computing (MEC), or client-server computing may be used. For example, the electronic device 1001 may provide an ultra-low latency service by using distributed computing or mobile edge computing. In another embodiment, the external electronic device 1004 may include an Internet of Things (IoT) device. The server 1008 may be an intelligent server using machine learning and/or a neural network. According to an embodiment, the external electronic device 1004 or the server 1008 may be included in the second network 1099. The electronic device 1001 may be applied to an intelligent service (e.g., a smart home, a smart city, a smart car, or a healthcare) based on 5G communication technology and IoT-related technology.

The electronic device according to various embodiments disclosed in the disclosure may be various types of devices. The electronic device may include, for example, a portable communication device (e.g., a smartphone), a computer device, a portable multimedia device, a mobile medical appliance, a camera, a wearable device, or a home appliance. An electronic device according to an embodiment of this specification may not be limited to the above-described electronic devices.

Various embodiments of the disclosure and terms used herein are not intended to limit the technical features described in the disclosure to specific embodiments, and it should be understood that the embodiments and the terms include modification, equivalent, or alternative on the corresponding embodiments described herein. With regard to description of drawings, similar or related components may be marked by similar reference marks/numerals. The singular form of the noun corresponding to an item may include one or more of items, unless interpreted otherwise in context. In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component. Thus, for example, “connected” as used herein covers direct and indirect connections.

In various embodiments of the disclosure, the term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment, the module may be implemented in the form of an application-specific integrated circuit (ASIC). Thus, each “module” herein may comprise circuitry.

Various embodiments of the disclosure may be implemented with software (e.g., program 1040) including one or more instructions stored in a storage medium (e.g., the embedded memory 1036 or the external memory 1038) readable by a machine (e.g., the electronic device 1001). For example, the processor (e.g., the processor 1020) of the machine (e.g., the electronic device 1001) may call at least one instruction of the stored one or more instructions from a storage medium and then may execute the at least one instruction. This enables the machine to operate to perform at least one function depending on the called at least one instruction. The one or more instructions may include a code generated by a compiler or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

According to an embodiment, a method according to various embodiments disclosed herein may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store (e.g., PlayStore™), directly between two user devices (e.g., smartphones), or online. In the case of on-line distribution, at least part of the computer program product may be at least temporarily stored in the machine-readable storage medium such as the memory of a manufacturer's server, an application store's server, or a relay server or may be generated temporarily.

According to various embodiments, each component (e.g., a module or a program) of the above-described components may include a single entity or a plurality of entities, and some of the plurality of objects may be separately arranged on other components. According to various embodiments, one or more components of the above-described components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments, operations executed by modules, programs, or other components may be executed by a successive method, a parallel method, a repeated method, or a heuristic method. Alternatively, at least one or more of the operations may be executed in another order or may be omitted, or one or more operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a communication circuit;
a memory; and
at least one processor, comprising processing circuitry, individually and/or collectively configured to:
generate a first image by at least downsampling an original image;
generate a second image by at least removing a partial component included in the first image from the first image;
generate a difference image between the first image and the second image;
determine a number of times that the difference image is stepwise upsampled to have a resolution corresponding to a resolution of the original image;
generate an upsampled difference image by at least stepwise upsampling the difference image the determined number of times;
generate a final image, which corresponds to the resolution of the original image and in which the partial component is removed from the original image, based on the original image and the upsampled difference image; and
store the final image in the memory.

2. The electronic device of claim 1, wherein the at least one processor is individually and/or collectively configured to:
recognize whether a computational memory exceeds a predetermined threshold value;
split the difference image into a plurality of tile images when the computational memory exceeds the threshold value;
stepwise upsample the plurality of tile images the determined number of times; and
generate the final image based on the original image and the upsampled plurality of tile images.

3. The electronic device of claim 1, wherein the at least one processor is individually and/or collectively configured to:
add padding to edges of the plurality of tile images;
stepwise upsample the padding-added plurality of tile images;
crop the upsampled padding-added plurality of tile images; and
generate the final image based on the original image and the cropped plurality of tile images.

4. The electronic device of claim 1, wherein the at least one processor is individually and/or collectively configured to:
generate an intermediate original image by at least downsampling the original image so as to have a resolution corresponding to an intermediate difference image upsampled by a number of times less than the determined number of times while stepwise upsampling the difference image;
generate an intermediate result image based on the intermediate difference image and the intermediate original image;
recognize whether the generated intermediate result image corresponds to a specified resolution; and
perform a specified operation based on the intermediate result image when the intermediate result image corresponds to the specified resolution.

5. The electronic device of claim 4, wherein the specified operation includes an operation of providing the intermediate result image as an image for editing.

6. The electronic device of claim 4, further comprising:
a display,
wherein the specified resolution includes a resolution of a specified preview image, and
wherein the specified operation includes an operation of outputting the intermediate result image as the preview image through the display.

7. The electronic device of claim 1, further comprising:
a camera,
wherein the at least one processor is individually and/or collectively configured to:
obtain the original image through the camera.

8. The electronic device of claim 1, wherein the at least one processor is individually and/or collectively configured to:
obtain the original image from an external electronic device through the communication circuit.

9. The electronic device of claim 1, wherein the at least one processor is individually and/or collectively configured to:
determine the number of times based on a ratio between the resolution of the original image and a resolution of the first image, and a specified upsampling magnification.

10. The electronic device of claim 1, wherein the at least one processor is individually and/or collectively configured to:
request an external electronic device to perform at least some of a stepwise upsampling operation the determined number of times; and
receive a result of performing at least some of the stepwise upsampling operation the determined number of times from the external electronic device.

11. The electronic device of claim 1, wherein the at least one processor is individually and/or collectively configured to:
remove the partial component included in the first image from the first image using a trained artificial intelligence learning model.

12. The electronic device of claim 1, the partial component includes at least one of a shadow image and a light reflection image that are included in the first image.

13. An image processing method of an electronic device, the method comprising:
generating a first image by at least downsampling an original image;
generating a second image by at least removing a partial component included in the first image from the first image;
generating a difference image between the first image and the second image;
determining a number of times that the difference image is stepwise upsampled to have a resolution corresponding to a resolution of the original image;
generating an upsampled difference image by at least stepwise upsampling the difference image the determined number of times;
generating a resulting image, based on the resolution of the original image and in which the partial component is removed from the original image, based on the original image and the upsampled difference image; and
storing the resulting image.

14. The method of claim 13, wherein the generating of the resulting image includes:
recognizing whether a computational memory of a processor of the electronic device exceeds a predetermined threshold value;
splitting the difference image into a plurality of tile images when the computational memory exceeds the threshold value;
stepwise upsampling the plurality of tile images the determined number of times; and
generating the resulting image based on the original image and the upsampled plurality of tile images.

15. The method of claim 13, further comprising:
generating an intermediate original image by at least downsampling the original image so as to have a resolution corresponding to an intermediate difference image upsampled by a number of times less than the determined number of times while stepwise upsampling the difference image;
generating an intermediate result image based on the intermediate difference image and the intermediate original image;
recognizing whether the generated intermediate result image corresponds to a specified resolution; and
performing a specified operation based on the intermediate result image when the intermediate result image corresponds to the specified resolution.

16. The method of claim 15, wherein the performing of the specified operation includes at least one of: providing the intermediate result image as an image for editing, and outputting the intermediate result image as a preview image.

17. The method of claim 13, wherein the determining of the number of times includes:
determining the number of times based on a ratio between the resolution of the original image and a resolution of the first image, and a specified upsampling magnification.

18. The method of claim 13, wherein the generating of the second image includes:
removing the partial component included in the first image from the first image by using a trained artificial intelligence learning model.

19. The method of claim 18, wherein the partial component includes at least one of a shadow image and a light reflection image that are included in the first image.

20. The method of claim 14, wherein the stepwise upsampling of the plurality of tile images includes:
adding padding to edges of the plurality of tile images; and
stepwise upsampling the padding-added plurality of tile images, and wherein the generating of the resulting image includes:
cropping the upsampled padding-added plurality of tile images; and
generating the resulting image based on the original image and the cropped plurality of tile images.
